(19) United States
(12) Patent Application Publication
(10) Pub. No.: US 2020/0286501 A1
(43) Pub. Date: Sep. 10, 2020

(54) APPARATUS AND A METHOD FOR SIGNAL ENHANCEMENT

(71) Applicant: Huawei Technologies Co., Ltd., Shenzhen (CN)

(72) Inventors: Wei XIAO, Shenzhen (CN); Wenyu JIN, Shenzhen (CN)

(21) Appl. No.: 16/847,239

(22) Filed: Apr. 13, 2020

Related U.S. Application Data
(63) Continuation of application No. PCT/EP2017/076134, filed on Oct. 12, 2017.

(51) Int. Cl. G10L 21/0208; G10L 25/84

(52) U.S. Cl. CPC G10L 21/0208; G10L 25/84

(57) ABSTRACT

A signal enhancer includes an input configured to receive an audio signal. It also includes a processor that is configured to generate at least two different filters based on the audio signal X of a current frame. The processor is also configured to generate at least two filtered signals by applying each of the at least two filters to the audio signal of the current frame respectively. The processor is further configured to generate an enhanced audio signal Y for the current frame by merging the n filtered signals. This improves the robustness of the signal enhancement.

### CROSS-REFERENCE TO RELATED APPLICATIONS

This application is a continuation of International Application No. PCT/EP2017/076134, filed on Oct. 12, 2017. The aforementioned application is hereby referenced in its entirety.

### FIELD

This disclosure relates to an apparatus and a method for signal enhancement.

### TECHNICAL BACKGROUND

It can be helpful to enhance a speech component in a noisy signal. For example, speech enhancement is desirable to improve the subjective quality of voice communication, e.g., over a telecommunications network. Another example is automatic speech recognition (ASR). If the use of ASR is to be extended, it needs to improve its robustness to noisy conditions. Some commercial ASR solutions are quite performant. For example, they may, achieve a word error rate (WER) of less than 10%. However, this performance is often reached only under good conditions, with little noise. The WER can be larger than 40% under complex noise conditions.

One approach to enhancing speech is to capture the audio signal with multiple microphones and to filter those signals with an optimum filter. The optimum filter can be an adaptive filter that is adapted to a given frame of the audio signal. In adapting the filter, the filter is subject to certain constraints. For example, the optimum filter can be a noise-reduction filter, which maximises the signal-to-noise ratio (SNR). This technique is based primarily on noise control and gives little consideration to auditory perception. It is not sufficiently robust under high noise levels. Too strong noise reduction processing can also attenuate the speech component, resulting in poor ASR performance.

Another approach is based primarily on control of the foreground speech, as speech components tend to have distinctive features compared to noise. This approach increases the power difference between speech and noise by using the so-called “noise masking effect”. According to psychoacoustics, if the power difference between two signal components is large enough, the masker (with higher power) will mask the maskee (with lower power) so that the maskee is no longer audibly perceptible. The resulting signal is an enhanced signal with higher intelligibility.

One technique that makes use of the masking effect is Computational Auditory Scene Analysis (CASA). It works by detecting the speech component and the noise component in a signal and masking the noise component. One example of a CASA method is described in CN105096961. An overview is shown in FIG. 1 of the present application. In this technique, one of a set of multiple microphone signals is selected as a primary channel and processed to generate a target signal. This target signal is then used to define the constraint for an optimal filter to generate an enhanced speech signal. This technique makes use of a binary mask, which is generated by setting time and frequency bins in the spectrum of the primary signal that are below a reference power to zero and bins above the reference power to one. This is a simple technique and, although CN105096961 proposes some additional processing, the target signal generated by this method generally has many spectrum holes. The additional processing also introduces some undesirable complexity, including a need for two time-frequency transforms and their inverses.

### SUMMARY

The present disclosure provides improved concepts for signal enhancement in an audio signal.

A first aspect of the present disclosure provides a signal enhancer. The signal enhancer comprises an input configured to receive an audio signal X. It also comprises a processor configured to generate n different filters based on the audio signal X of a current frame, wherein n≥2. The processor is also configured to generate n filtered signals by applying each of the n filters to the audio signal of the current frame respectively. The processor is further configured to generate an enhanced audio signal Y for the current frame by merging the n filtered signals.

This aspect thus involves generating two or more different filters (e.g., a noise-reduction filter and a noise-masking filter) and applying them to the audio signal of the current frame, thereby obtaining at least two filtered signals. Each of the filters is configured to enhance one characteristic of the audio signal. For example, a first one of the filters may be a noise-reduction filter, while a second one of the filters may be a noise-masking filter. In this case, the first filter will generally increase a signal-noise-ratio (SNR) of the audio signal while the second filter will generally improve the intelligibility of speech in the audio signal. The enhanced audio signal is generated by merging of the filtered signals. Thus, a compromise between the two or more filtered signals can be made. The audio signal can thus be enhanced in a robust manner.

In a first implementation form of the first aspect, the processor may be configured to, for each of the n filters, generate a target signal S based on the audio signal of the current frame. The processor may be further configured to generate the respective filter so that a filtered signal Z obtained by applying the filter to the audio signal of the current frame approximates the target signal S.

Each filter can be generated, for example, by using an optimization algorithm for determining parameters of the respective filter so as to minimize a measure of a difference between the filtered signal Z and the target signal S. Generating each filter thus comprises determining parameters of the filter based on the audio signal and the target signal. The parameters of the filter can thus be obtained in a limited amount of time.

In a second implementation form of the first aspect, the operation of generating the respective filter comprises adapting the filter to the target signal S iteratively in one or more iterations. By adapting the parameters of the filter (e.g., by adding a quantity, or by subtracting a quantity), a satisfactory result (i.e., the parameters of the filter) can be obtained in a limited number of iterations. This provides an efficient way of generating the filter.

In a third implementation form of the first aspect, the operation of generating the respective filter comprises terminating adapting the filter when a measure of a difference between the filtered signal Z and the target signal S is below a predefined threshold. This provides an efficient way of generating the filter.

In a fourth implementation form of the first aspect, the set of n filters includes a first filter and a second filter. Each of the first filter and the second filter comprises one of the following: a noise-reduction filter, a noise-masking filter, a de-reverberation filter, a linear beam-forming filter, or an echo-cancellation filter. This provides particularly effective signal enhancement, as each of these filters enhances another characteristic of the audio signal.

In a fifth implementation form of the first aspect, the signal enhancer comprises a pre-processor configured to pre-process the audio signal of the current frame. The pre-processed audio signal of the current frame is used as the audio signal of the current frame in the above mentioned operation of generating the n filtered signals. In other words, the n filtered signals are generated by applying each of the n filters to the pre-processed audio signal of the current frame, respectively.

The pre-processor e improves the audio signal that is input to the n filters. The audio signal can thus be enhanced in an even more robust manner.

In a sixth implementation form of the first aspect, the set of n filters includes a first filter and a second filter. Each of the first filter, the second filter, and the pre-processor is one of the following filter types: a noise reduction filter, a noise-masking filter, a de-reverberation filter, a linear beam-forming filter, or an echo-cancellation filter, wherein it is understood that the first filter, the second filter, and the pre-processor are of different filter types. Particularly effective and robust signal enhancement can thus be achieved.

In a seventh implementation form of the first aspect, the noise-reduction filter is configured to perform a noise reduction on the audio signal of a current super frame. The current super frame comprises the current frame, i.e. the frame that is processed. This provides an implementation of noise-reduction filter.

In an eighth implementation form of the first aspect, the noise-masking filter is configured to perform a noise masking operation on a plurality of spectral components of the audio signal of the current super frame. This provides an implementation of noise-reduction filter.

In a ninth implementation form of the first aspect, the noise masking operation is based on a plurality of estimated noise power components. Each noise power component is an estimated noise power of a respective spectral component of the audio signal of the current super frame.

This provides a way of implementing the noise masking operation. The noise is masked in the spectral domain, which can be done with less complexity than in the time-domain.

In a tenth implementation form of the first aspect, the plurality of spectral components in the audio signal of the current frame corresponds to a windowed frame of the audio signal of the current frame.

An edge effect in the spectral-domain processing can thus be reduced.

In an eleventh implementation form of the first aspect, the processor may be configured to generate the enhanced audio signal as a weighted sum of the n filtered signals.

This provides a robust way of merging the n filtered signals (n≥2). By generating the enhanced audio signal according to a weighted sum of the n filtered signals, a compromise between the n different filtered signals (e.g., a noise reduction filtered signal and a noise masking filtered signal) can be reached, the speech enhancement can thus become more robust.

In a twelfth implementation form of the first aspect, the weighted sum is generated on the basis of n weight values. The n weight values are either pre-determined or determined based on the audio signal of the current frame.

This provides a two possible ways of determining the n weight values.

In a thirteenth implementation form of the first aspect, the n weight values are based on a detected probability of speech presence in the audio signal of the current frame.

This provides an adaptive method of determining the n weight values. By obtaining the n weight values according to the detected probability of speech in each audio signal of the current frame, the accuracy of the enhanced audio signal can be improved.

In a fourteenth implementation form of the first aspect, the n weight values are equal to a minimum value between a ratio and 1. The ratio is a result of the detected probability of speech presence divided by a predefined value.

This provides one way of adaptively determining the n weight values.

In a fifteenth implementation form of the first aspect, the signal enhancer is implemented in a voice communication terminal or in an automatic speech recognition system.

A second aspect of the disclosure provides a method for signal enhancing. The method comprises obtaining an audio signal X. The method also comprises generating n filters based on an audio signal X of a current frame, wherein n≥2. In addition, the method comprises generating n filtered signals by applying each of the n filters to the audio signal of the current frame respectively, and generating an enhanced audio signal Y for the current frame by merging the n filtered signals.

A third aspect of the disclosure provides a non-transitory machine readable storage medium. The non-transitory machine readable storage medium has stored thereon processor executable instructions implementing a method. That method comprises obtaining an audio signal X and generating n filters based on an audio signal X of a current frame, wherein n≥2. It further comprises generating n filtered signals by applying each of the n filters to the audio signal of the current frame respectively. The method comprises generating an enhanced audio signal Y for the current frame by merging the n filtered signals.

A fourth aspect of the disclosure provides a computer program with a program code for performing a method according to any one of the embodiments of the second aspect of the invention when the computer program runs on a computer.

A fifth aspect of the disclosure provides a terminal device which comprises a signal enhancer according to any one of the embodiments of the first aspect of the invention.

The implementation forms of the first aspect and their technical effects can be easily translated into implementation forms of the other aspects. Those implementation forms of the other aspects are not listed here in order to avoid redundancy.

### BRIEF DESCRIPTION OF THE FIGURES

In the following, embodiments of the present disclosure are described in more detail with reference to the attached figures and drawings. Similar or corresponding details in the figures are marked with the same reference numerals.

FIG. 1 relates to a technique for enhancing speech signals;

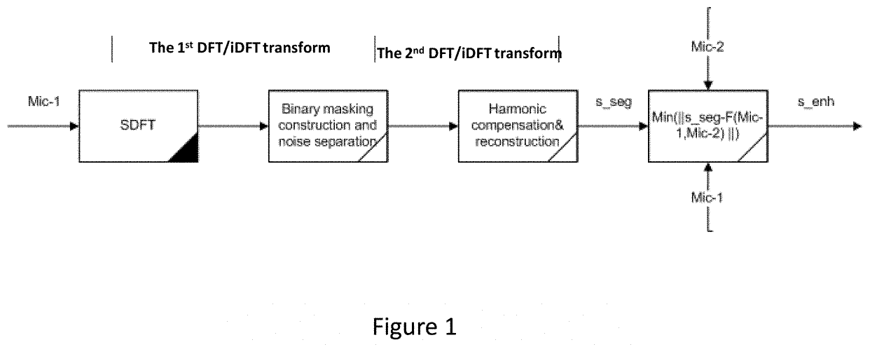

FIG. 2 shows an example of a signal enhancer according to an embodiment of the disclosure;

FIG. 3 shows an example of a block diagram for signal enhancer according to an embodiment of the disclosure;

FIG. 4 shows an example of a process for enhancing a signal according to an embodiment of the disclosure;

FIG. 5 shows an exemplary process for enhancing speech in an audio signal according to an embodiment; and

FIG. 6 shows an exemplary process for enhancing speech in an audio signal according to another embodiment.

### DETAILED DESCRIPTION

Illustrative embodiments of a method, an apparatus, and a program product for speech enhancement of an audio signal are described with reference to the figures. Although this description provides a detailed example of possible implementations, it should be noted that the details are intended to be exemplary and in no way limit the scope of the disclosure.

Moreover, the description of an embodiment/example may be applicable partly or entirely to other embodiments/examples. For example, a description including but not limited to terminology, element, process, explanation and/or technical advantage mentioned in one embodiment/example is applicative to the other embodiments/examples.

Loosely speaking, the proposed mechanism for speech enhancement makes use of a technique of constraint satisfaction. Constraint satisfaction is a process of finding a solution to a mathematical problem with a set of constraints to be satisfied by the solution. In a signal enhancement technique (e.g., speech enhancement), noise reduction may be seen as a constraint that serves to minimize the noise in the audio signal (i.e. increase the signal-noise-ratio, SNR). Noise masking may be seen as another constraint, which serves to keep the intelligibility of the speech in the audio signal. Various other constraints can be employed, e.g., de-reverberation, linear beam forming, or echo-cancellation. De-reverberation (also known as deconvolution) serves to reduce reverberation of a physical or virtual space in the audio signal. Beam forming is a signal processing technique for use with microphone arrays. It generates a directional audio signal from a multi-channel audio signal. The directional audio signal is generated by combining signals from microphones of the microphone array in such a way that signals at particular angles experience constructive interference while others experience destructive interference. The concept of echo-cancellation derives from telephony, and the general idea is to synthesize an estimate of an echo from the speaker's signal and to subtract that synthesized echo signal from the return path (e.g., instead of switching attenuation into/out of the path).

Each constraint defines a filter which, when applied to the input audio signal, produces an output audio signal that satisfies the constraint. The above listed constraints thus define a plurality of filters, e.g., a noise-reduction filter, a noise-masking filter, a de-reverberation filter, a beam-forming filter, and an echo-cancellation filter.

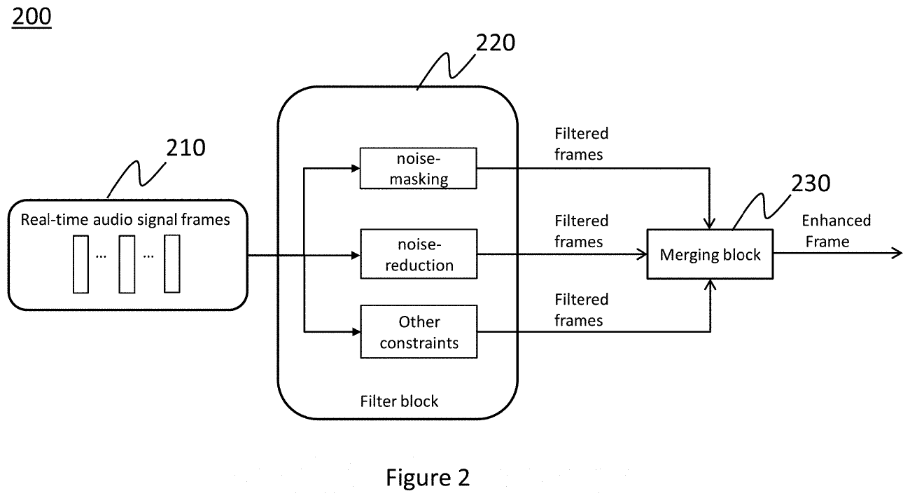

An exemplary mechanism of a signal enhancer 200 is shown in FIG. 2. The signal enhancer 200 comprises an input 210, a filter block 220, and a merging block 230. In operation, the input 210 receives an audio signal in a sequence of successive time frames, e.g., in the form of a real-time audio stream. For each frame, the filter block 220 generates two or more filtered audio signals based on the audio signal of the respective frame. Each of the filters complies with a constraint. Each constraint is associated with one or more operations in which the respective filter is applied to the audio signal to obtain a filtered audio frame that satisfies the respective constraint. The merging block 230 merges the filtered audio frames into a single enhanced audio frame. Thus, a trade-off between different constraints is made.

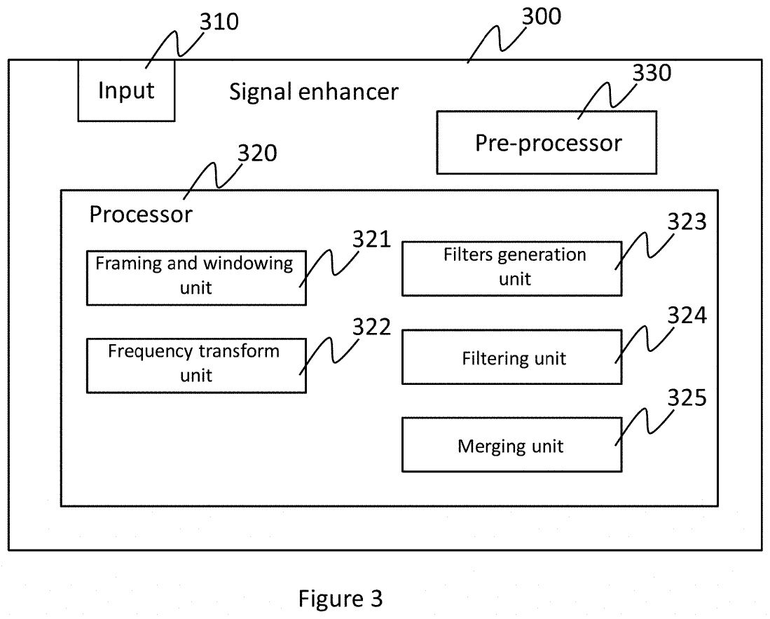

An exemplary embodiment of signal enhancer is shown in FIG. 3. The signal enhancer, shown at 300, comprises an input 310 and a processor 320.

The input 310 receives an audio signal. The audio signal includes a component that is wanted (e.g., speech) and a component that is unwanted (e.g., noise). The audio signal comprises a plurality of consecutive audio frames. The audio signal may represent any kind of sound, in particular sound captured by a microphone. The audio signal may be a single-channel audio signal, or a multi-channel signal. A multi-channel audio signal comprises two or more audio channels. Each channel may, for example, represent audio from one microphone. The wanted component will usually be speech. The unwanted component will usually be noise. If a microphone is in an environment that includes speech and noise, it will typically capture an audio signal that comprises both. The wanted and unwanted components are not limited to being speech or noise, however. They could be of any type of signal.

The processor 320 comprises a framing and windowing unit 321 that splits the input audio signal into a plurality of frames. The processor may further apply a window function to the plurality of frames. The window function defines for each frame an enlarged frame (referred to herein as a super frame) that comprises the respective frame and which extends beyond that frame. A super frame is a time interval, which comprises a given frame and which may extend beyond the beginning and/or the end of that frame. For example, the super frame associated with a given frame may extend partly or fully across the previous frame and/or the next frame. The current frame may thus be associated with a current super frame, which comprises the current frame. In some embodiments, there is no difference between super frames and frames—in this case each frame and its corresponding super frame are the same time interval. In some embodiments, the super frame associated with a given frame comprises that frame and its preceding frame. In this case, when each frame has a length T, each super frame has a length 2*T. The current super frame is a generalized definition. When performing the implementation, there are two options: a first option, the current super frame comprises only the current frame being processed; a second option, the current frame comprises the current frame being processed, and also a previous adjacent frame.

Just as an example, the framing and windowing unit 321 applies a 50% overlapping window function (i.e., Hann function) to a current frame and a previous adjacent frame. The current frame and the previous adjacent frame together form the current super frame. By applying the window function to the plurality of frames, the spectrum between adjacent frames can be smoothened, and the edge effect in spectral domain is decreased.

The processor 320 further comprises a frequency transform unit 322 that splits each input super frame into a plurality of spectral components, or, equivalently, generates a plurality of spectral coefficients for the input super frame. The spectral coefficients may be Fourier coefficients. Each spectral component is located in a particular frequency band or bin. The sum of the spectral components constitutes the input super frame. Just as an example, the frequency transform unit 322 may be implemented by a fast Fourier transformer.

The processor 320 also includes a filters generation unit 323 that generates n different filters, wherein n≥2. Each different filter filters the input audio signal to obtain an output signal that complies with an associating constraint. For example, the filters generation unit 323 generates two filters, a first filter and a second filter. Each of the first filter and the second filter may comprise, for example, one of the following: a noise-reduction filter, a noise-masking filter, a de-reverberation filter, a linear beam-forming filter, or an echo-cancellation filter. The filters generation unit 323 generates, for each of the at least two filters, a target signal S based on the audio signal of the current frame. The filters generation unit 323 generates the respective filter so that a filtered signal Z obtained by applying the filter to the audio signal of the current frame approximates the target signal S. The respective filter may be generated, for example, by adapting the filter to the target signal S iteratively in one or more iterations. Just as an example, the operation of adapting the filter may be terminated when a measure of a difference between the filtered signal Z and the target signal S is below a predefined threshold.

The processor 320 also comprises a filtering unit 324 that generates n filtered signals by applying each of the n filters to the audio signal of the current frame, respectively.

The processor 320 shown in FIG. 3 also comprises a merging unit 325 that generates an enhanced audio signal Y for the current frame by merging the n filtered signals. For example, the merging unit 325 may generate the enhanced audio signal as a weighted sum of the n filtered signals.

The signal enhancer 300 may further comprise a pre-processor 330 that pre-processes the audio signal of the current frame, and uses the pre-processed audio signal of the current frame as the audio signal of the current frame in the operation of generating the n filtered signals. The pre-processor 330 may be implemented as one of the following filters: a noise-reduction filter, a noise-masking filter, a de-reverberation filter, a linear beam-forming filter, or an echo-cancellation filter. Note that the pre-processor should be implemented as a filter different from the n generated filters. For example, if the two generated filters are a noise-reduction filter and a noise-masking filter, respectively, then the pre-processor can be for example a de-reverberation filter, or a linear beam-forming filter, or an echo-cancellation filter.

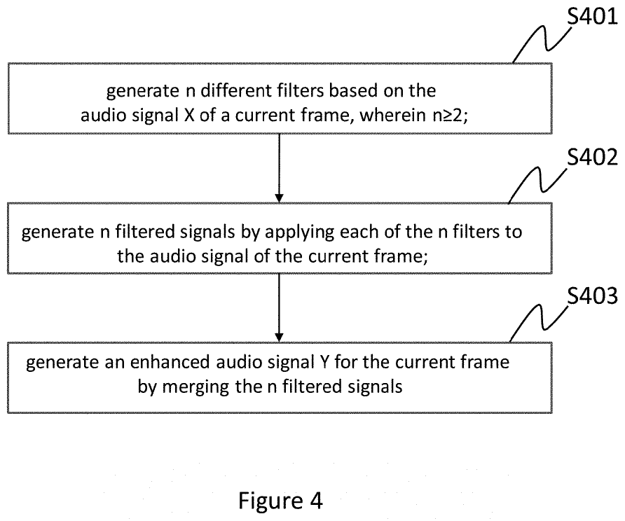

An example of a method for signal enhancing is shown in FIG. 4. The method starts in step s401 with generating n different filters based on the audio signal X of a current frame, wherein n≥2. In step s402, the n filtered signals are generated by applying each of the n filters to the audio signal of the current frame. In step s403, an enhanced audio signal for the current frame is generated by merging the n filtered signals.

The structures shown in FIG. 3 (and all the block apparatus diagrams included herein) are intended to correspond to a number of functional blocks. This is for illustrative purposes only. FIG. 3 is not intended to define a strict division between different parts of hardware on a chip or between different programs, procedures or functions in software. In some embodiments, some or all of the signal processing techniques described herein are performed wholly or partly in hardware. This particularly applies to techniques incorporating repetitive operations such as Fourier transforms and threshold comparisons. In some implementations, at least some of the functional blocks are likely to be implemented wholly or partly by a processor acting under software control. Any such software is suitably stored on a non-transitory machine readable storage medium. The processor may, for example, be a DSP of a mobile phone, smart phone, tablet or any generic user equipment or generic computing device, or any other kind of circuitry configured for executing the operations described in this application.

The apparatus and method described herein can be used to implement speech enhancement in a system that uses signals from any number of microphones. In one example, the techniques described herein can be incorporated in a multi-channel microphone array speech enhancement system that uses spatial filtering to filter multiple inputs and to produce a single-channel, enhanced output signal.

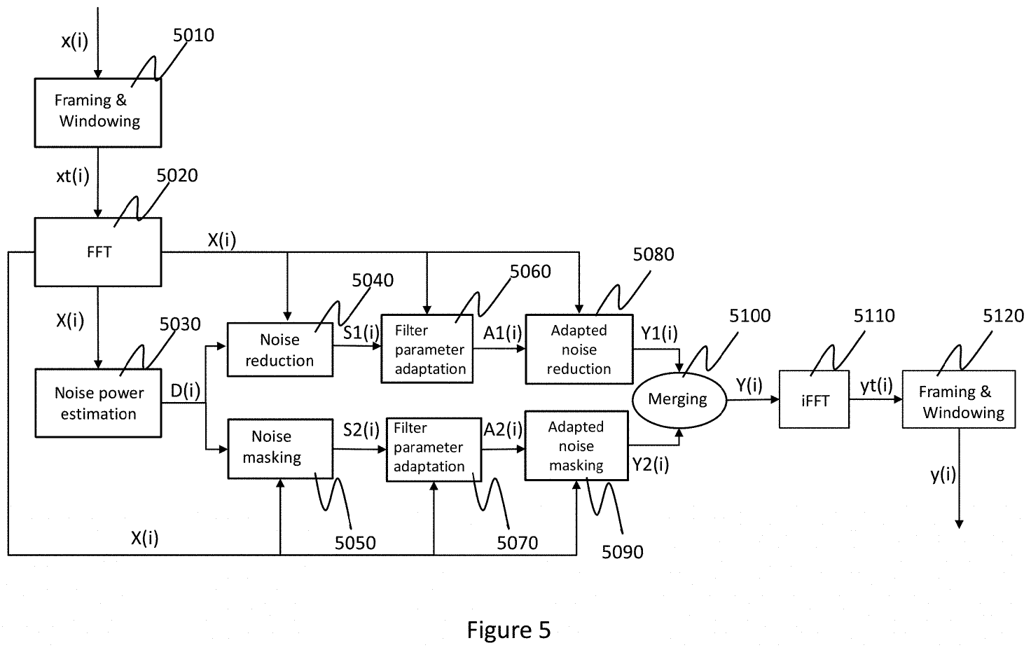

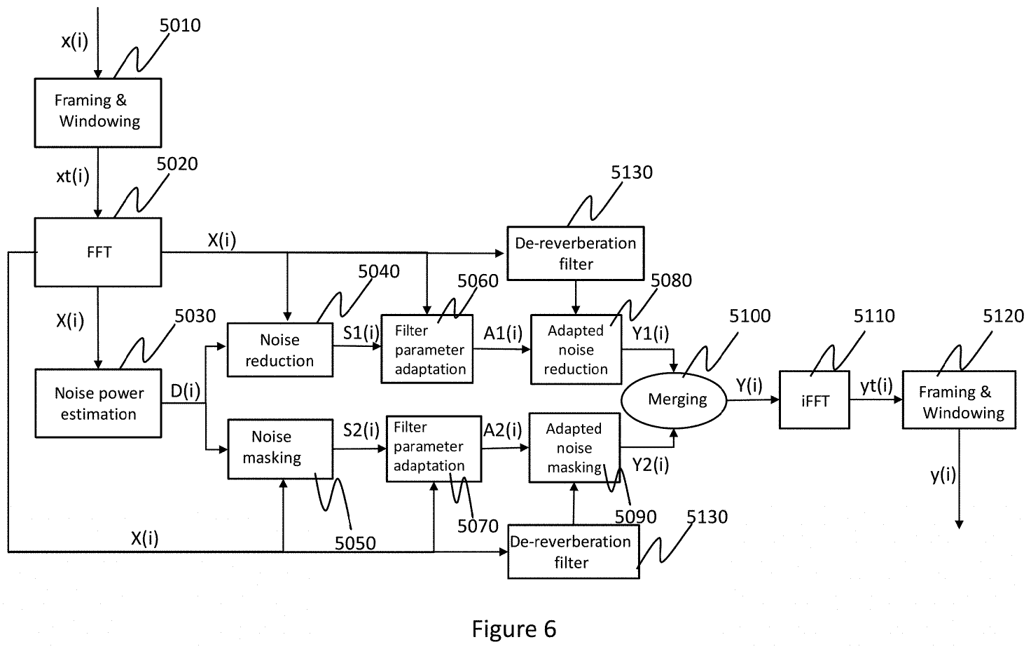

A more detailed embodiment of a speech enhancement technique is shown in FIG. 5. The embodiment is described below with reference to some of the functional blocks shown in FIG. 3. The embodiments may apply to a single-channel audio signal and to a multi-channel audio signal alike. For multiple channels, each channel can be processed separately. For simplicity, FIGS. 5 and 6 and the description below describe the processing of a single channel audio signal x(i), “i” being the frame index. For ease, a method step and a unit (e.g., SNR constraint filter 5040) involved in that step may be designated by the same reference numerals (e.g., 5040).

Step 5010: A single channel audio signal is input into the system. This audio signal is processed by a framing and windowing unit 5010 to output a series of super frames xt(i).

In this step, for example, assume the time-domain input data, x(i), which could be a single channel or multi-channel microphone signal, is segmented into audio frames. Each frame may comprises a sequence of audio samples. The frames may all have the same length in time. The frames may all comprise the same number of audio samples. For example, the frame length is 10 ms at 16 kHz sampling rate. Accordingly, the number of samples in each frame will be 160. A windowing operation (e.g., a 50% overlap windowing operation such as Hanning window) is performed on each frame x(i) (frame index: “i”) together with the previous adjacent frame (frame index: i−1), to get a new signal in time domain, xt(i) of the input signal. xt(i) is a super frame in which frames x(i−1) and x(i) are concatenated. For example, the size of output xt(i) is 320 samples for the 10 ms frame length and 16 kHz sampling rate.

Step 5020: Each super frame xt(i) is processed by a Fast Fourier Transform (FFT) unit 5020, to output a series of Fourier coefficients (i.e. frequency coefficients) X(i). Each frequency coefficient X(i,k) represents the amplitude of the spectral component in frequency bin k.

An FFT 5020 is performed for each frame of the input signal 501. If the sampling rate is 16 kHz, the frame size might be set as 16 ms. This is just an example and other sampling rates and frame sizes could be used. It should also be noted that there is no fixed relationship between sampling rate and frame size. So, for example, the sampling rate could be 48 kHz with a frame size of 16 ms. A 320-point FFT can be implemented over the input signal of the current frame. Performing the FFT generates a series of complex-valued coefficients X(i,k) in the frequency domain. These coefficients are Fourier coefficients and can also be referred to as spectral coefficients or frequency coefficients. Note that un this application, the index k=0, 1, 2, 3, etc. may be the coefficient index of the signal in the time domain or in the frequency domain.

Step 5030: The noise power D(i) associated with each of the spectral components is then estimated by a noise power estimation 5030 using the spectral coefficients X(i).

In this step, any kinds of noise estimation methods, for non-stationary or stationary, can be used to obtain the estimated noise power D(i).

Any suitable noise estimation (NE) method can be used for this estimation. A simple approach is to average the power density of each coefficient over the current frame and one or more previous frames. According to speech processing theory, this simple approach may be most suitable for scenarios in which the audio signal is likely to contain stationary noise. Another option is to use advanced noise estimation methods, which tend to be suitable for scenarios incorporating non-stationary noise. In some embodiments, a reference power estimator may be configured to select an appropriate power estimation algorithm in dependence on an expected noise scenario, e.g., whether the noise is expected to be stationary or non-stationary in nature.

Step 5040: The estimated noise power D (i) is used by a noise filter 5040 (e.g., a SNR constraint filter 5040), to generate a target signal S1 (i) for the current super frame xt(i). The noise filter can be implemented by a plurality of methods. For example, spectral subtraction algorithm (Tanmay Biswas et al, Audio De-noising by Spectral Subtraction Technique Implemented on Reconfigurable Hardware, in 2014 Seventh International Conference on Contemporary Computing (IC3)), Time-Frequency Block Thresholding (Guoshen Yu et al, Audio Denoising by Time-Frequency Block Thresholding, IEEE TRANSACTIONS ON SIGNAL PROCESSING, VOL. 56, NO. 5, MAY 2008), a noise filter of the kind described by Wenyu Jin et al, MULTI-CHANNEL NOISE REDUCTION FOR HANDS-FREE VOICE COMMUNICATION ON MOBILE PHONES, in proceeding of ICASSP 2017, describing non-stationary noise estimation and noise reduction, in which the noise estimation is used for a noise reduction operation.

Step 5050: The estimated noise power D(i) is used by a noise masking filter 5050, (e.g., a CASA constraint filter 5050) to generate a target signal S2(i) for the current super frame xt(i).

For example, the noise masking filter 5050 may be a signal enhancer as described in the claims and in the description of international patent application number PCT/EP2017/051311, filed by HUAWEI TECHNOLOGIES CO., LTD on Jan. 23, 2017. A list of embodiments described in that application is appended to the present description.

Step 5060: The target signal S1(i) and the frequency coefficients X(i) are used to determine a first filter A1, also referred to as the first adaptive filter A1.

The filter A1(i) may be determined by an algorithm for filtering X(i) subject to the constraint of the target signal S1(i). Any suitable algorithm might be used. For example, an the filter A1(i) may be determined by minimizing the quantity:

∥A₁(i)·X(i)−S(i)∥²

i.e., the L2 norm of the difference between the filtered signal A₁(i)·X(i) and the target signal S(i). The minimization can be done iteratively in one or more iterations. The iterative process can be stopped, for example, after a predefined number of iterations or when the quantity ∥A₁(i)·X(i)−S(i)∥² is less than a predefined threshold. Taking the filter A1(i−1) from the preceding frame as an initial value for the first iteration, and predefining the number of iterations to be fairly small, and/or predefining the threshold to be fairly large, abrupt changes of the filter A1 from one frame to the next frame can be avoided to some extent, thus making the evolution of the filter A1 from one frame to the next frame smooth. This can result in better final audio quality. Furthermore, an unnecessarily high number of iterations can thus be avoided.

The primary aim in an ASR scenario is to increase the intelligibility of the audio signal that is input to the ASR block. The original microphone signals are optimally filtered. Preferably, no additional noise reduction is performed to avoid removing critical voice information. For a voice communication scenario, a good trade-off between subjective quality and intelligibility should be maintained. Noise reduction should be considered for this application. Therefore, the microphone signals may be subjected to noise reduction before being optimally filtered.

Step 5070: The target signal S2(i) and the frequency coefficients X(i) are used to determine a second filter A2, also referred to as the second adaptive filter A2.

The filter A2(i) may be determined by an algorithm for filtering X(i) subject to the constraint of the target signal S2(i). Any suitable algorithm might be used. For example, an the filter A2(i) may be determined by minimizing the quantity:

∥A₂(i)·X(i)−S(i)∥²

i.e. the L2 norm of the difference between the filtered signal A₂(i)·X(i) and the target signal S(i). The minimization can be done iteratively in one or more iterations. The iterative process can be stopped, for example, after a predefined number of iterations or when the quantity ∥A₂·X(i)−S(i)∥² is less than a predefined threshold. Taking the filter A2(i−1) from the preceding frame as an initial value for the first iteration, and predefining the number of iterations to be fairly small, and/or predefining the threshold to be fairly large, abrupt changes of the filter A2 from one frame to the next frame can be avoided to some extent, thus making the evolution of the filter A2 from one frame to the next frame smooth. This can result in better final audio quality. Furthermore, an unnecessarily high number of iterations can thus be avoided.

Step 5080: A filtered signal Y1(i) is obtained by performing adapted noise reduction on the current super frame.

Just as an example, the filtered signal Y1(i) may be obtained by multiplying 5080 the parameters of noise-reduction filter A1 (e.g., SNR constraint filter) with the spectral coefficients X(i) of the current super frame: Y1(i)=A1(i)*X(i).

Filtering may also be implemented by convolution in time domain, e.g.

$$y 1 [ n ] = {\sum }_{m = - M}^{M} x ( n - m ) * a 1 ( m )$$

Wherein y1[n] is the filtered signal Y1(i) in time domain and a1 is the pulse response related to the noise-reduction filter A1.

Step 5090: A filtered signal Y2(i) is obtained by performing adapted noise masking on the current super frame.

Just as an example, the filtered signal Y2(i) may be obtained by multiplying 5090 the parameters of the noise masking filter A2 (e.g., CASA constraint filter) with the spectral coefficients X(i) of the current super frame: Y2(i)=A2(i)*X(i).

Filtering may also be implemented by convolution in time domain, e.g.

$$y 2 [ n ] = {\sum }_{m = - M}^{M} x ( n - m ) * a 2 ( m )$$

Here, y2[n] is the filtered signal Y2(i) in time domain and a2 is the pulse response related to the noise masking filter A2.

Step 5100: A merging operation 5100 is performed on the two filtered signals Y1 (i) and Y2 (i) to obtain the merged result Y(i).

For example, the merging operation 5100 may be implemented in a simple way by calculating a weighted sum of the two filter signals Y1(i) and Y2(i). The two weighted value may be either pre-defined or determined based on the audio signal of the current frame.

For example, the merged result Y(i)=(w1*Y1(i)+w2*Y2(i)), “i” is the frame index, the weighted value are pre-defined, e.g., in the scenario of voice communication, w1 and w2 are suggested to be 0.7 and 0.3 respectively, in order to give more weight on the result of noise reduction filtering. In the scenario of speech recognition, w1 and w2 are suggested to be 0.2 and 0.8 respectively to give more weight on the result of noise masking filtering.

Alternatively, instead of pre-defined weighting values, the speech presence probability method (T. Gerkmann et al, “Unbiased MMSE-Based Noise Power Estimation With Low Complexity and Low Tracking Delay,” in IEEE Transactions on Audio, Speech, and Language Processing, vol. 20, no. 4, pp. 1383-1393, May 2012.) can also be referred, and the above weighted-summation may be implemented adaptively. The speech presence probability is a value between 0 and 1, where 1 indicates complete speech presence, and 0 refers to noise estimation in previous frame. Assuming the active estimated speech presence probability is σᵢ, (j) for i^{th} frame, j^{th} frequency bins (σᵢ (j)ϵ[0, 1]) based on a selected channel of microphone signals. The following formulation is shown to adaptively adjust the constraint weightings:

Y(j)=(w(j)*Y1(j)+w(j)*Y2(j)),

Here, w (j)=min (σᵢ (j)/0.7, 1).

Step 5110: The inverse spectral transform (e.g. inverse fast Fourier transform (iFFT)) 5110 is performed on the merged result signal Y(i) to obtain the time-domain signal yt(i).

For example, the iFFT 5110 transform the series of Fourier coefficients Y(i) (i.e. frequency coefficients) to output a series of Fourier coefficients (i.e. frequency coefficients) into the enhanced audio signal (i.e., the enhanced super frame corresponding to the current super frame) yt(i) in time domain.

Step 5120: The time-domain enhanced audio signal y(i) is obtained by applying the framing and windowing operation to the time-domain signal yt(i).

For example, the operation of obtaining y(i) from yt(i) is an inverse process of obtaining xt(i) from x(i).

FIG. 6 shows a specific example of a pre-processing of the audio signal. Comparing with the processing procedure shown in FIG. 5, in FIG. 6, before performing an adapted noise reduction 5080 or an adapted noise masking 5090 respectively, the input signal of the current frame X(i) is performed by a pre-processing (e.g., de-reverberation filtering 5130) to get a pre-processed signal Xp(i) as an input of the adapted noise reduction 5080 or the adapted noise masking 5090 to obtain the filtered signals Y1(i) and Y2(i).

In block 5080 of FIG. 6, the filtered signal Y1(i)=Xp(i)*A1(i). In block 5090 of FIG. 6, the filtered signal Y2(i)=Xp(i)*A2(i).

In FIG. 6, the pre-processing is implemented by a de-reverberation filter. It is know that the pre-processing may be any one or a combination of the following filters: for example, a noise-reduction filter, a noise-masking filter, a de-reverberation filter, a linear beam-forming filter, or an echo-cancellation filter.

The de-reverberation filter may be implemented by a “Coherent-to-Diffuse Power Ratio Estimation for Dereverberation” algorithm (Andreas Schwarz et al., IEEE/ACM Transactions on Audio, Speech, and Language Processing, Volume: 23, Issue: 6, June 2015) and a “Robust sparsity-promoting acoustic multi-channel equalization for speech dereverberation” (Ina Kodrasi et al., 2016 IEEE International Conference on Acoustics, Speech and Signal Processing (ICASSP)) algorithm as the candidate de-reverberation method. In the former reference document, the Coherent-to-Diffuse Power Ratio-based derevereberation method takes two channel microphone signals as input and the output is one-channel dereverberated signals. In the latter reference document, dereverebration is achieved by multi-channel equalization techniques using measured room impulse responses. For example, if a dereverberation filter is chosen as the pre-processing filter, at least two channels of microphone signal are needed; if a noise reduction filter or a noise masking filter is chosen as the pre-processing filter, one or more channel of microphone signal is needed.

The linear beam-forming filter may be implemented by the following methods: delay-sum beamforming, minimum variance distortionless response (MVDR) and linearly constrained minimum variance (LCMV) beamforming.

In FIG. 6 the incoming signals are again processed in frames. This achieves real-time processing of the signals. Each incoming signal may be divided into a plurality of frames with a fixed frame length (e.g., 16 ms). The same processing is applied to all frames. The single channel input may be termed “Mic-1”. This input may be one of a set of microphone signals that all comprise a component that is wanted, such as speech, and a component that is unwanted, such as noise. The set of signals need not be audio signals and could be generated by methods other than being captured by a microphone.

In both these examples, the multiple microphone array has two microphones. This is solely for the purposes of example. It should be understood that the techniques described herein might be beneficially implemented in a system having any number of microphones, including systems based on single channel enhancement or systems having arrays with three or more microphones.

It should be understood that where this explanation and the accompanying claims refer to the device doing something by performing certain steps or procedures or by implementing particular techniques that does not preclude the device from performing other steps or procedures or implementing other techniques as part of the same process. In other words, where the device is described as doing something “by” certain specified means, the word “by” is meant in the sense of the device performing a process “comprising” the specified means rather than “consisting of” them.

The applicant hereby discloses in isolation each individual feature described herein and any combination of two or more such features, to the extent that such features or combinations are capable of being carried out based on the present description as a whole in the light of the common general knowledge of a person skilled in the art, irrespective of whether such features or combinations of features solve any problems disclosed herein, and without limitation to the scope of the claims. The applicant indicates that aspects of the present disclosure may consist of any such individual feature or combination of features. In view of the foregoing description it will be evident to a person skilled in the art that various modifications may be made within the scope of the disclosure.

Some embodiments of a noise masking filter (e.g., the noise masking block in FIG. 2, or the noise masking branch 5050, 5070, 5090 in FIG. 5 or 6) are listed below, referred to below as a signal enhancer.

### Embodiment 1

A signal enhancer, which comprises:

an input configured to receive an audio signal that has a wanted component and an unwanted component;

a perception analyser configured to:

split the audio signal into a plurality of spectral components;

for each spectral component, designate that spectral component as belonging to the wanted component or the unwanted component in dependence on a power estimate associated with that spectral component; and

if that spectral component is designated as belonging to the unwanted component, adjust its power by applying an adaptive gain to that spectral component, wherein the adaptive gain is selected in dependence on how perceptible the spectral component is expected to be to a user.

### Embodiment 2

A signal enhancer according to embodiment 1, wherein the perceptual analyser is configured to, for each spectral component that is designated as belonging to the unwanted component, compare its power estimate with a power threshold, and:

if the power estimate is below the power threshold, select the adaptive gain to be a gain that will leave the power associated with that spectral component unchanged; and

if the power estimate is above the power threshold, select the adaptive gain to be a gain that will reduce the power associated with that spectral component.

### Embodiment 3

A signal enhancer according to embodiment 2, wherein the power threshold is selected in dependence on a power at which that spectral component is expected to become perceptible to the user.

### Embodiment 4

A signal enhancer according to embodiment 2 or 3, wherein the power threshold is selected in dependence on how perceptible a spectral component is expected to be to a user given a power associated with one or more of the other spectral components.

### Embodiment 5

A signal enhancer according to any of embodiments 2 to 4, wherein the perception analyser is configured to select the power threshold for each spectral component in dependence on a group associated with that spectral component, wherein the same power threshold is applied to the power estimates for all the spectral components comprised in a specific group.

### Embodiment 6

A signal enhancer according to embodiment 5, wherein the perception analyser is configured to select the power threshold for each group of spectral components to be a predetermined threshold that is assigned to that specific group in dependence on one or more frequencies that are represented by the spectral components in that group.

### Embodiment 7

A signal enhancer according to embodiment 5 or 6, wherein the perception analyser is configured to determine the power threshold for a group of spectral components in dependence on the power estimates for the spectral components in that specific group.

### Embodiment 8

A signal enhancer according to embodiment 7, wherein the perception analyser is configured to determine the power threshold for a specific group of spectral components by:

identifying the highest power estimated for a spectral component in that specific group; and

generating the power threshold by decrementing that highest power by a predetermined amount.

### Embodiment 9

A signal enhancer according to any one of embodiments 5 to 8, wherein the perception analyser is configured to select the power threshold for a group of spectral components by comparing:

a first threshold, which is assigned to that specific group in dependence on one or more frequencies that are represented by the spectral components in that group; and

a second threshold, which is determined in dependence on the power estimates for the spectral components in that group;

the perception analyser being configured to select, as the power threshold for the group, the lower of the first and second thresholds.

### Embodiment 10

A signal enhancer according to any one of embodiments 2 to 9, wherein the perception analyser is configured to, for each spectral component that is designated as: (i) belonging to the unwanted component; and (ii) having a power estimate that is above the power threshold, select the adaptive gain to be a ratio between the power threshold and the power estimate for that spectral component.

### Embodiment 11

A signal enhancer according to any one of embodiments 1 to 10, wherein the signal enhancer comprises a transform unit configured to:

receive the audio signal in the time domain and convert that signal into the frequency domain, whereby the frequency domain version of the audio signal represents each spectral component of the audio signal by a respective coefficient;

wherein the perception analyser is configured to adjust the power associated with a spectral component by applying the adaptive gain to the coefficient that represents that spectral component in the frequency domain version of the audio signal.

### Embodiment 12

A signal enhancer according to embodiment 11, wherein the perception analyser is configured to form a target audio signal that comprises:

non-adjusted coefficients that represent the spectral components designated as belonging to the wanted component of the audio signal; and

adjusted coefficients that represent the spectral components designated as belonging to the unwanted component of the audio signal.

### Embodiment 13

A signal enhancer according to embodiment 12, wherein the transform unit is configured to receive the target audio signal in the frequency domain and convert it into the time domain, wherein an output of the signal enhancer is configured to output the time domain version of the target audio signal.

1. A signal enhancer, the signal enhancer comprising:
an input configured to receive an audio signal X; and
a processor configured to:
generate n different filters based on the audio signal X of a current frame, wherein n≥2;
generate n filtered signals by applying each of the n filters to the audio signal X of the current frame, respectively; and
generate an enhanced audio signal Y for the current frame by merging the n filtered signals,
wherein the processor is configured to: generate the enhanced audio signal as a weighted sum of the n filtered signals,
wherein the n weight values are based on a detected probability of speech presence in the audio signal X of the current frame.

2. The signal enhancer of claim 1, wherein the processor is configured to, for each of the n filters:
generate a target signal S based on the audio signal X of the current frame; and
generate a respective filter, of the n filters, so that a filtered signal Z, of the n filtered signals, obtained by applying the respective filter to the audio signal X of the current frame, approximates the target signal S.

3. The signal enhancer of claim 2, wherein the operation of generating the respective filter comprises adapting the respective filter to the target signal S iteratively in one or more iterations.

4. The signal enhancer of claim 3, wherein the operation of generating the respective filter comprises terminating adapting the respective filter upon determining that a measure of a difference between the filtered signal Z and the target signal S is below a predefined threshold.

5. The signal enhancer of claim 1,
wherein the set of n filters comprises a first filter and a second filter, and
wherein each of the first filter and the second filter comprises one of the following: a noise-reduction filter, a noise-masking filter, a de-reverberation filter, a linear beam-forming filter, or an echo-cancellation filter.

6. The signal enhancer of claim 1, the signal enhancer comprising a pre-processor configured to:
pre-process the audio signal X of the current frame, and use the pre-processed audio signal of the current frame as the audio signal of the current frame in the operation of generating the n filtered signals.

7. The signal enhancer of claim 6,
wherein the set of n filters comprises a first filter and a second filter, and
wherein each of the first filter, the second filter, and the pre-processor is chosen discriminately from one of the following: a noise-reduction filter, a noise-masking filter, a de-reverberation filter, a linear beam-forming filter, or an echo-cancellation filter.

8. The signal enhancer of claim 5, wherein the noise-reduction filter is configured to perform a noise reduction on an audio signal of a current super frame, the current super frame comprising the current frame.

9. The signal enhancer of claim 5, wherein the noise-masking filter is configured to perform a noise masking operation on a plurality of spectral components of an audio signal of a current super frame, the current super frame comprising the current frame.

10. The signal enhancer of claim 9, wherein the noise masking operation is based on a plurality of estimated noise power components, each noise power component being an estimated noise power of a respective spectral component of the audio signal of the current super frame.

11. The speech enhancer of claim 9, wherein the plurality of spectral components in the audio signal of the current frame corresponds to a windowed frame of the audio signal of the current frame.

12. (canceled)

13. The signal enhancer of claim 1, wherein the weighted sum is generated on the basis of n weight values, which are either pre-determined or determined based on the audio signal of the current frame.

14. (canceled)

15. The signal enhancer of claim 1,
wherein the n weight values are equal to a minimum value between a ratio and 1, and
wherein the ratio is a result of the detected probability of speech presence divided by a predefined value.

16. The signal enhancer of claim 1, wherein the signal enhancer is implemented in a voice communication terminal or in an automatic speech recognition system.

17. A method for signal enhancement, the method comprising:
receiving an audio signal X;
generating n filters based on the audio signal X of a current frame, wherein n≥2;
generating n filtered signals by applying each of the n filters to the audio signal X of the current frame, respectively; and
generating an enhanced audio signal Y for the current frame by merging the n filtered signals.

18. A non-transitory machine readable storage medium having stored thereon processor executable instructions implementing a method, the method comprising:
receiving an audio signal X;
generating n filters based on the audio signal X of a current frame, wherein n≥2;
generating n filtered signals by applying each of the n filters to the audio signal X of the current frame respectively; and
generating an enhanced audio signal Y for the current frame by merging the n filtered signals
wherein the processor is configured to: generate the enhanced audio signal as a weighted sum of the n filtered signals,
wherein the n weight values are based on a detected probability of speech presence in the audio signal X of the current frame.
